(19) United States
(12) Patent Application Publication
(10) Pub. No.: US 2009/0178378 A1
(43) Pub. Date: Jul. 16, 2009

(54) DEVICE FOR SEPARATING DUST FROM DUST-LADEN AIR, IN PARTICULAR FOR USE IN A VACUUM CLEANER

(75) Inventors: Andre Bertram, Bielefeld (DE); Stefan Tiekoetter, Bielefeld (DE)

Correspondence Address: DARBY & DARBY P.C., P.O. BOX 770, Church Street Station, New York, NY, 10008-0770, US

(73) Assignee: Miele & Cie KG, Guetersloh (DE)

(21) Appl. No.: 12/353,021

(22) Filed: Jan. 13, 2009

(30) Foreign Application Priority Data
Jan. 14, 2008 (DE) 10 2008 004 393.1

(51) Int. Cl. B01D 45/12

(52) U.S. Cl. 55/391; 55/428

(57) ABSTRACT

A device having a form of a cyclone separator, for separating dust from dust-laden air. The device includes a substantially rotationally symmetric container with a dust collection chamber. A tangentially disposed inlet is configured to provide air to the container. An axially disposed outlet configured to discharge air from the container. The container is configured such that a first flow velocity of the air flow in an inflow region of the outlet is lower than a second flow velocity of the air flow in a region of the inlet.

### CROSS REFERENCE TO RELATED APPLICATIONS

Priority is claimed to German patent application DE 10 2008 004 393.1, filed Jan. 14, 2008, which is hereby incorporated by reference herein

### FIELD

The present invention relates to a device for separating dust from dust-laden air, in particular for use in a vacuum cleaner, said device in the form of a cyclone separator having an at least nearly rotationally symmetric container to which the air is fed.

### BACKGROUND

Vacuum cleaners, in particular canister vacuum cleaners, use dust retention systems which are generally disposed between the air inlet of a dust collection chamber and the suction side of a fan and which retain the collected dust before it enters the fan. The best-known variant is a filter which is in the form of a bag and which is internally loaded, i.e., dust accumulates inside the bag. Generally, a fine dust filter is disposed downstream of the bag, the fine dust filter collecting dust particles which have a size of less than 2 μm and which have passed through the bag. As the number of allergic persons increases, it is increasingly important to remove this dust fraction from the ambient air because such particles are respirable because of their small size and, therefore, may have adverse effects on health. When the maximum collection capacity of about 400 grams is reached, the bag needs to be replaced. In the case of sealable bags in particular, this can be done in a hygienic manner, since the dust remains in the bag and is disposed of therewith. Depending on usage, replacement is required several times a year, which generates costs. The fine dust filter also needs to be replaced after a certain period of use, but the intervals are longer here because of the small amount of fine dust. Manufacturers recommend replacement after about one year. Due to the small particle sizes, the mass fraction of fine dust produced is small and, therefore, commercial fine dust filters have a capacity of about 10 grams.

Some mini vacuum cleaners, multipurpose vacuum cleaners, or industrial appliances use externally loaded filters, which enclose the fan. This provides higher collection capacity, but the filters of such vacuum cleaners are designed only for coarse dust. The fine dust, which contains allergenic pollens and microorganisms, passes through the filter and is blown back into the room by the fan, and is even stirred up in this process.

There is a desire for a filter system for coarse dust that can be reused and has the following features:
a compact design;
hygienic removal of the collected dust;
low losses in suction power;
low noise emission.

DE 199 11 331 C1 describes a washable and reusable textile filter bag. However, there are concerns with such bags, primarily with regard to hygiene, because the heavily soiled bags must first be manually emptied and then washed in a washing machine. EP 1 179 312 A2 describes dust cartridges made of porous sintered material. EP 0 647 114 B1 describes centrifugal separators, also referred to as “cyclone separators.”

The latter two systems allow the dust collection container to be easily removed, emptied, and cleaned if soiled. Conventional systems, in particular cyclone separators, attempt to simulate the dust separation known from dust bags. Therefore, for fan powers of 1500 to 2200 watts, which are common in conventional household vacuum cleaners, the cut size of the separators is very small, and the dust collection containers contain large quantities of respirable fine dust. As a result of this, during emptying of such containers, the lighter fractions of the dust being removed fly up and are dispersed in the air. This may have adverse effects, especially on people with allergies.

In order to avoid this, WO 2007/022959 A2 proposes to use a dust separation system which is based on an inertial separator and allows the dust to be separated into three fractions, the cut points being at dust particle sizes of 200 μm (first stage) and at 30 μm (second stage). In one embodiment, a dust-binding agent is added to the second fraction, which contains mainly dust particles having a size of between 30 μm and 200 μm.

FIG. 1 is a view of a conventionally constructed cyclone separator with tangential inflow. This cyclone separator is formed of an at least nearly rotationally symmetric (here cylindrical) container 1, and has a tangentially disposed inlet 2 through which the air is fed, and an axially disposed outlet in the form of a dip tube 3 extending into the container 1. The lower portion of the container, through which the dirt-laden air passes as it flows from inlet 2 to outlet 3, acts as a dust collection chamber 4.

The air enters container 1 through inlet 2 at an entry velocity v_{E} on a circular path of radius r_{E}, said radius corresponding to the mean distance of inlet 2 from the axis of symmetry 5 of container 1. In the process, an air vortex having an angular momentum L is generated, said angular momentum being proportional to the product of the entry radius and velocity:

L≈v_{E}×r_{E}

The air exits container 1 through outlet 3, in which process the air vortex contracts to radius r_{T} of dip tube 3 . Since the law of conservation of angular momentum, L=constant, applies here, tangential velocity v_{T} at dip tube 3 is derived as:

v_{T}=v_{E}×r_{E}/r_{T}

In conventional cyclone separators, r_{E} is always significantly greater than r_{T}; usually two to four times greater. However, this implies that tangential velocity v_{T} at dip tube 3 is also two to four times greater than entry velocity v_{E} at inlet 2. The decisive factor for the separation of the entrained dust particles is the centrifugal acceleration a_{T} at the dip tube, for which it holds that:

a_{T}≈v_{T}²

Thus, for a given v_{E}, the centrifugal acceleration is increased by a factor of 4 to 16. As a result, even minute particles are separated out. For fan powers of 1500 to 2200 watts, which are common in household vacuum cleaners, the cut size of these cyclone separators is on the order of 1 μm.

Therefore, conventional cyclone separators used in vacuum cleaners have the following disadvantages:
1. Because of the small cut size of about 1 μm, they may, indeed, substantially substitute for a dust bag, but they load the air for breathing with large quantities of respirable fine dust during emptying.
2. Due to the high velocities, the pressure drop across the cyclone also assumes high values.
3. Moreover, the high velocities result in the emission of high noise levels.

### SUMMARY

An aspect of the present invention is to provide a device for separating dust from dust-laden air, which, on the one hand, is based on the principle of a cyclone separator and therefore causes swirling of the dust particles in the dust collection container, and in which, on the other hand, the cut point is greater than the particle size of respirable fine dust (less than 2 μm).

In an embodiment, the present invention provides a device having a form of a cyclone separator, for separating dust from dust-laden air. The device includes a substantially rotationally symmetric container with a dust collection chamber. A tangentially disposed inlet is configured to provide air to the container. An axially disposed outlet configured to discharge air from the container. The container is configured such that a first flow velocity of the air flow in an inflow region of the outlet is lower than a second flow velocity of the air flow in a region of the inlet.

### BRIEF DESCRIPTION OF THE DRAWINGS

An exemplary embodiment of the present invention is described in more detail below and shown schematically in the drawings, in which:

FIG. 1 is a view of a cyclone separator of conventional construction;

FIG. 2 is a diagrammatic sketch of an improved cyclone separator;

FIG. 3 is a view showing the cyclone separator of FIG. 1 with an improved dip tube; and

FIG. 4 is a view showing the cyclone separator of FIG. 2 with a baffle plate.

### DETAILED DESCRIPTION

In an embodiment, the present invention provides a device for separating dust from dust-laden air, in particular for use in a vacuum cleaner, said device being in the form of a cyclone separator having an at least nearly rotationally symmetric container to which the air is fed through a tangentially disposed inlet, the air then being passed through a dust collection chamber and subsequently discharged through an axially disposed outlet.

The container is configured such that the flow velocity of the air flow in the inflow region of the outlet is lower than in the region of the inlet. This ensures that only large particles will remain in the dust collection chamber.

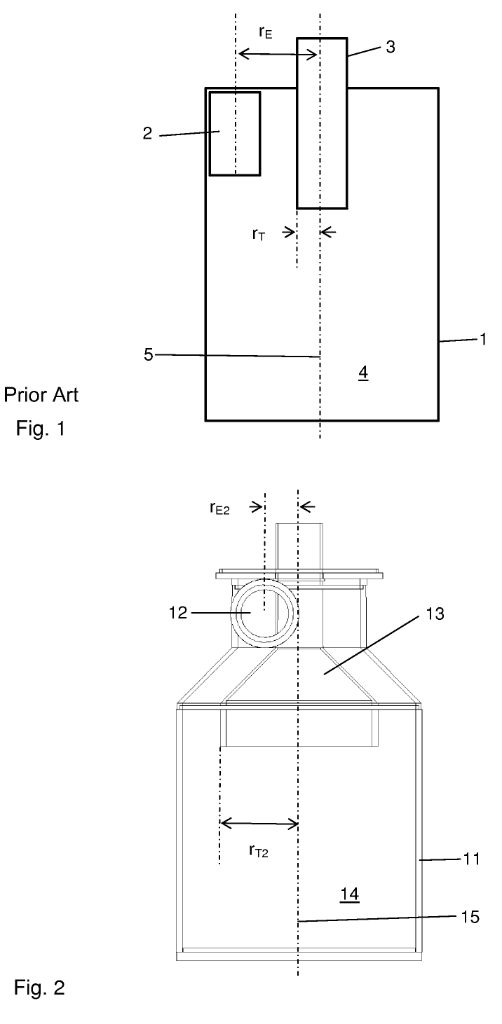

In the separator shown in FIG. 2, the disadvantages of a conventionally constructed cyclone separator are avoided in that the air entering dust collection chamber 14 in the lower portion of container 11 is decelerated instead of being accelerated. In accordance with the present invention, this is achieved in that radius r_{T2} of dip tube 13 is greater than the mean distance r_{E2} of inlet 12 from axis of symmetry 15. The air enters the container at an entry velocity v_{E2} at a small radius r_{E2}. Container 11 and dip tube 13 widen downwardly in the manner of a funnel. As a result, the radius of the vortex generated in the inlet region increases toward the inflow region of dip tube 13, and thus, the flow velocity of the air flow is decelerated because of the law of conservation of angular momentum and due to wall friction. Tangential velocity v_{T2} is then reduced by at least a factor of 10 compared to conventional cyclone separators with tangential inflow. This not only minimizes the pressure drop and noise emission, but also shifts the cut point to the range from 20-30 μm. Therefore, no fine dust will remain in dust collection container 14, which allows the dust collection container to be emptied without releasing dust into the air.

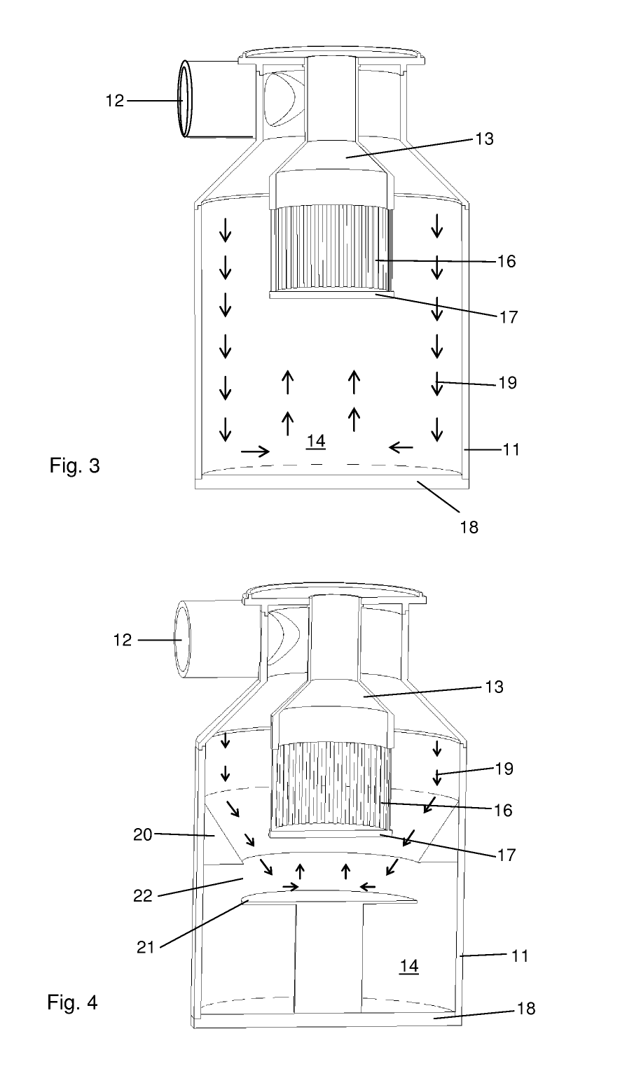

FIG. 3 is a longitudinal cross-sectional view of a separator in which fine dust separation is further improved by a specific configuration of dip tube 13. Particularly, the inflow region of dip tube 13 is surrounded by a grid 16 having a closed bottom 17. The grid-like structure fulfills two functions. First, it smoothes the flow that enters dip tube 3, thereby improving the separation efficiency of the cyclone separator. Moreover, it protects a downstream fine filter. In the event of malfunctions, (e.g., cyclone clogged, or bottom lid 18 improperly closed), relatively large amounts of relatively coarse dust could otherwise get into and clog the fine filter. Both functions could be implemented by the illustrated grid 16, but also by a screen structure or a perforated plate. The grid structure may be easier to clean, which is an advantage because fibers may get caught in the flow smoother not only during malfunctions, but occasionally also during normal operation.

In addition to the vortex described above, there is also a predominantly vertical secondary flow (indicated by arrows 19), which may stir up dirt particles that have accumulated on the container bottom due to centrifugal and gravitational forces. Therefore, dip tube 13 may be fluidically closed off by grid bottom 17 from the region therebelow, thus preventing the separated particles from being stirred up and carried away.

Another improvement consists in the creation of a calmed collection region, in which the secondary flow is reduced to such an extent that it is no longer able to stir up the separated particles. FIG. 4 illustrates the internal structural features that make it possible to create such a calmed collection region. These features include a conical ring 20 which directs the secondary flow inwardly, and a round baffle plate 21 whose diameter is approximately equal to the smallest diameter of the conical ring and which blocks the remaining vertical component of the secondary flow.

Larger particles (>30 μm), which are separated out in the region of dip tube grid 16, are moved into the gap 22 between ring 20 and baffle plate 21 by the secondary flow and by gravity. There, they are forced outwardly by the centrifugal force and downwardly by gravitation, and are thereby moved to the lower portion of dust collection container 14 between bottom lid 18 and baffle plate 21.

The initial cyclone vortex is only slightly obstructed by internal structural features 20 and 21, because said structural features are rotationally symmetric. Therefore, the vortex is still present in the collection region in a weaker form and may used to mix the separated dust with a binding agent.

Ring 20 and baffle plate 21 are shown here in interaction with one another, but each of them alone already reduces the vertical component of secondary flow 19.

The present invention is not limited to the embodiments described herein; reference should be had to the appended claims.

What is claimed is:

1: A device having a form of a cyclone separator, for separating dust from dust-laden air, the device comprising:
a substantially rotationally symmetric container including a dust collection chamber;
a tangentially disposed inlet configured to provide air to the container; and
an axially disposed outlet configured to discharge air from the container,
wherein the container is configured such that a first flow velocity of the air flow in an inflow region of the outlet is lower than a second flow velocity of the air flow in a region of the inlet.

2: The device as recited in claim 1, wherein the device is configured for use in a vacuum cleaner.

3: The device as recited in claim 1, wherein a mean distance of the inlet from an axis of symmetry of the container is smaller than a radius of the outlet.

4: The device as recited in claim 1, wherein the container widens from the inlet toward the dust collection chamber.

5: The device as recited in claim 3, wherein the container widens from the inlet toward the dust collection chamber.

6: The device as recited in claim 4, wherein the container widens so as to form a widened portion having a shape of a funnel.

7: The device as recited in claim 1, wherein the outlet includes a dip tube extending into the dust collection chamber.

8: The device as recited in claim 2, wherein the outlet includes a dip tube extending into the dust collection chamber.

9: The device as recited in claim 3, wherein the outlet includes a dip tube extending into the dust collection chamber.

10: The device as recited in claim 4, wherein the outlet includes a dip tube extending into the dust collection chamber.

11: The device as recited in claim 6, wherein the outlet includes a dip tube extending into the dust collection chamber.

12: The device as recited in claim 7, wherein the dip tube tapers in a manner of a funnel starting at the inflow region.

13: The device as recited in claim 7, further comprising a screen surrounding at least a portion of the dip tube.

14: The device as recited in claim 13, wherein the screen has a closed bottom.

15: The device as recited in claim 7, further comprising a grid surrounding at least a portion of the dip tube.

16: The device as recited in claim 15, wherein the grid has a closed bottom.

17: The device as recited in claim 15, further comprising a conical ring surrounding at least a portion of the grid.

18: The device as recited in claim 16, further comprising a conical ring surrounding at least a portion of the grid in a vicinity of the closed bottom.

19: The device as recited in claim 17 further comprising a baffle plate disposed below the conical ring.

20: The device as recited in claim 18 further comprising a baffle plate disposed below the conical ring.
